(19) United States
(12) Patent Application Publication
(10) Pub. No.: US 2026/0235437 A1
(43) Pub. Date: Aug. 13, 2026

(54) TEST APPARATUS, TEST METHOD, AND COMPUTER PROGRAM PRODUCT

(71) Applicant: ADVANTEST CORPORATION, Tokyo (JP)

(72) Inventor: Takashi KUSAKA, Saitama (JP)

(21) Appl. No.: 19/632,389

(22) Filed: Mar. 29, 2026

Related U.S. Application Data
(63) Continuation of application No. PCT/JP2024/037032, filed on Oct. 17, 2024.

(30) Foreign Application Priority Data
Oct. 24, 2023 (JP) 2023-182447

(51) Int. Cl. G01J 1/42

(52) U.S. Cl. CPC G01J 1/42; G01J 2001/4252

(57) ABSTRACT

Provided is a test apparatus, including: a propagation unit which propagates input light including n (n is a natural number) wavelengths from a device under test with n propagation wavelength characteristics; an optical power detection unit which detects optical powers of n beams of propagation light propagated from the propagation unit with the n propagation wavelength characteristics; and an optical power calculation unit which calculates an optical power for each of the n wavelengths included in the input light, from the optical powers of the n beams of propagation light detected by the optical power detection unit, based on the n propagation wavelength characteristics.

### The contents of the following patent application(s) are incorporated herein by reference:

NO. 2023-182447 filed in JP on Oct. 24, 2023

NO. PCT/JP 2024/037032 filed in WO on Oct. 17, 2024.

### BACKGROUND

### 1. Technical Field

The present invention relates to a test apparatus, a test method, and a computer program product.

### 2. Related Art

Patent Document 1 describes that “According to the WDM optical amplifier, a gain equalization means having a variable loss wavelength characteristic is provided, and the variable loss wavelength characteristic is controlled according to a change in input optical power, so that a gain wavelength characteristic of an optical amplification means that changes according to input optical power can be reliably compensated, and thus output light having a flat wavelength characteristic can be obtained” (paragraph 0105). In the machine translation of Patent Document 2, “When the data analysis module (109) calibrates the flat spontaneous emission spectrum, the spectral shape abrupt change of the sampled signal at a short wavelength can be considered, and the power variation of the input and output ASE at the sampling point is combined to be corrected and calibrated” (paragraph 0061).

### RELATED ART DOCUMENTS

### Patent Documents

Patent Document 1: Japanese Patent Application Publication No. 2000-252923

Patent Document 2: CN 105281827 A

### BRIEF DESCRIPTION OF THE DRAWINGS

FIG. 1 is a schematic diagram of a test system according to one embodiment.

FIG. 2 is a diagram for schematically describing a method of detecting an optical power of each of n wavelengths included in input light from a DUT by the test apparatus according to one embodiment.

FIG. 3 is a diagram for describing an example of n propagation wavelength characteristics of a propagation unit in the test apparatus according to one embodiment.

FIG. 4 is a diagram for describing an example of n propagation wavelength characteristics of the propagation unit in the test apparatus according to one embodiment.

FIG. 5 is a diagram for describing an example of n propagation wavelength characteristics of the propagation unit in the test apparatus according to one embodiment.

FIG. 6 is a diagram for describing an example of n propagation wavelength characteristics of the propagation unit in the test apparatus according to one embodiment.

FIG. 7 is a flowchart illustrating an example of an operation flow of calculating first to eighth propagation wavelength characteristics by the test apparatus according to one embodiment.

FIG. 8 is a diagram for describing an example of a method of calculating first to eighth propagation wavelength characteristics by the test apparatus according to one embodiment.

FIG. 9 is a flowchart illustrating an example of an operation flow of detecting the optical power of each of n wavelengths included in input light from the DUT by the test apparatus according to one embodiment.

FIG. 10 is a diagram for describing an example of a method of calculating an optical power of each of wavelengths λ₁ to λ₈ included in the input light from the DUT by the test apparatus according to one embodiment.

FIG. 11 illustrates an example of a computer in which a plurality of aspects of the present invention is wholly or partially embodied.

### DESCRIPTION OF EXEMPLARY EMBODIMENTS

Hereinafter, the invention will be described through embodiments of the invention, but the following embodiments do not limit the invention according to claims. In addition, not all of the combinations of features described in the embodiments are essential to the solving means of the invention.

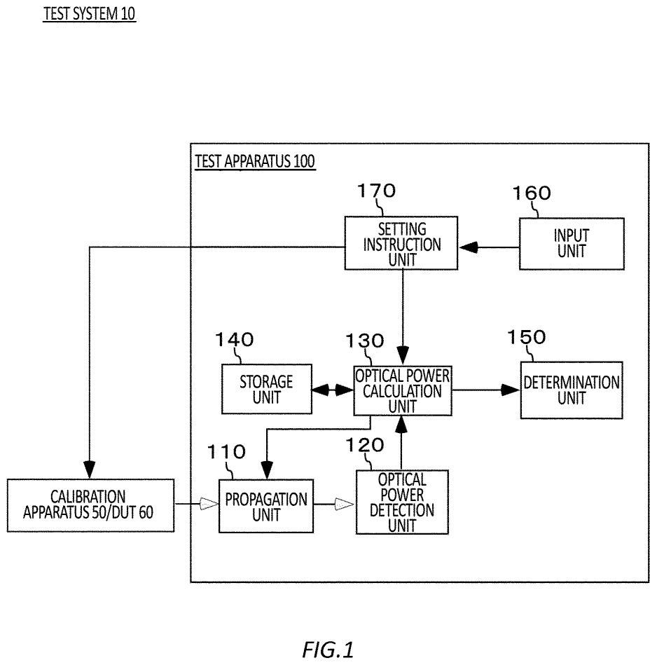

FIG. 1 is a schematic diagram of a test system 10 according to one embodiment. In FIG. 1, a traveling direction of light is indicated by a white arrow, and a flow direction of a signal is indicated by a black arrow. The same applies to following drawings, and redundant description will be omitted.

The test system 10 includes a calibration apparatus 50, a device under test (DUT) 60, and a test apparatus 100. In the test system 10, the test apparatus 100 communicates with each of the calibration apparatus 50 and the DUT 60 by wireless connection or wired connection. The test system 10 detects an optical power of each wavelength of light including a plurality of different wavelengths emitted from the DUT 60 by using a plurality of propagation wavelength characteristics in the test apparatus 100.

In the test system 10 according to the present embodiment, in order to detect the optical power of each wavelength of the light emitted from the DUT 60, the calibration apparatus 50 is provided at an arrangement place of the DUT 60 on an input side of the test apparatus 100. In the test system 10, the calibration apparatus 50 inputs reference input light having a known wavelength and optical power to the test apparatus 100. Accordingly, the test system 10 identifies a plurality of propagation wavelength characteristics in the test apparatus 100 in advance. The test system 10 according to the present embodiment also determines pass/fail of the DUT 60 based on the detected optical power of each wavelength of the DUT 60.

The calibration apparatus 50 is an apparatus that emits light according to setting values of a wavelength and an optical power. The calibration apparatus 50 sets a plurality of wavelengths and a plurality of optical powers respectively corresponding to the plurality of wavelengths in accordance with an instruction received from the test apparatus 100, and sequentially emits light of each set wavelength and the corresponding optical power toward the test apparatus 100.

The DUT 60 emits light including a plurality of different wavelengths. The DUT 60 is an example of a device under test that emits light at n (n is a natural number) mutually different wavelengths. As an example, the DUT 60 according to the present embodiment emits light by itself and outputs light including a plurality of different wavelengths. The DUT 60 according to the present embodiment is arranged on the input side of the test apparatus 100 such that light emitted by itself is received by the test apparatus 100.

The DUT 60 according to the present embodiment may be one or more light-emitting elements, and may be, for example, one or more LEDs. The LED may be a micro LED having a dimension of 100 μm or less, a mini LED having a dimension larger than 100 μm and 200 μm or less, or an LED having a dimension larger than 200 μm. The DUT 60 may be, for example, an LD or the like in addition to the LED. Alternatively, the DUT 60 may be an optical modulator that modulates and outputs light including a plurality of different wavelengths input from a multi-wavelength light source without emitting light by itself. In this case, the multi-wavelength light source may include, for example, a distributed feedback (DFB) laser, a Fabry-Perot (FP) laser, a fiber Bragg grating (FBG) laser, or the like.

The test apparatus 100 detects an optical power of each wavelength of input light emitted from the DUT 60 and including n mutually different wavelengths. In other words, when light including n wavelengths is input from the DUT 60, the test apparatus 100 detects an optical power of each of the n wavelengths. The test apparatus 100 according to the present embodiment applies a current or a voltage having a predetermined magnitude to the DUT 60, and detects the optical power of each wavelength of the DUT 60 in this manner, thereby testing optical characteristics of the DUT 60.

In order to detect the optical power of each wavelength of the DUT 60, the test apparatus 100 according to the present embodiment also transmits an instruction to cause the calibration apparatus 50 to set a plurality of wavelengths and a plurality of optical powers respectively corresponding to the plurality of wavelengths. Further, when reference input light having a known wavelength and optical power is input from the calibration apparatus 50, the test apparatus 100 detects an optical power that has changed due to a propagation wavelength characteristic of the test apparatus 100 in a process in which the light propagates in the test apparatus 100.

As an example, the test apparatus 100 may detect an optical power of light in a wavelength range of approximately tens of nanometers, that is, may detect an optical power of input light in which an interval between a shortest wavelength and a longest wavelength is approximately tens of nanometers. As an example, the test apparatus 100 may detect an optical power of input light in which an interval between adjacent wavelengths is about several nm. In other words, the DUT 60 and the calibration apparatus 50 may emit light in a wavelength range of approximately tens of nanometers or may emit light in which an interval between adjacent wavelengths is about several nm.

The test apparatus 100 according to the present embodiment includes a propagation unit 110, an optical power detection unit 120, an optical power calculation unit 130, a storage unit 140, a determination unit 150, an input unit 160, and a setting instruction unit 170. As illustrated in FIG. 1, in the test apparatus 100, the propagation unit 110 and the optical power detection unit 120 are arranged such that light from the DUT 60 and the calibration apparatus 50 arranged outside the test apparatus 100 reaches the optical power detection unit 120 after passing through the propagation unit 110. A waveguide using, for example, an optical fiber may be provided between the propagation unit 110 and the optical power detection unit 120.

The propagation unit 110 can switch n or more mutually different propagation wavelength characteristics with respect to the input light from the DUT 60. When light including n wavelengths is input, the propagation unit 110 propagates the input light with at least n propagation wavelength characteristics. As an example, the propagation unit 110 propagates input light including n wavelengths from the DUT 60, with n propagation wavelength characteristics. In other words, when receiving the input light including the n wavelengths from the DUT 60, the propagation unit 110 propagates propagation light with each of the n propagation wavelength characteristics. When receiving the reference input light having a known wavelength and optical power from the calibration apparatus 50, the propagation unit 110 may also propagate reference propagation light with each of the n propagation wavelength characteristics. The above-described mutually different propagation wavelength characteristics are intended to be propagation wavelength characteristics independent of each other, and the propagation unit 110 may have same propagation wavelength characteristics, but counting the mutually different propagation wavelength characteristics does not include a number of the same propagation wavelength characteristics.

As an example, the propagation unit 110 may be capable of propagating light with 12 propagation wavelength characteristics that are switchable and mutually different, and in this case, when light including 8 wavelengths is input, the input light may be propagated with 8 propagation wavelength characteristics among the 12 propagation wavelength characteristics, or the input light may be propagated with 9 to 12 propagation wavelength characteristics.

At least one of the n propagation wavelength characteristics of the propagation unit 110 may be a characteristic of propagating propagation light including at least two wavelengths among the n wavelengths from the DUT 60. In other words, any of the n propagation wavelength characteristics of the propagation unit 110 may be a characteristic of propagating propagation light including at least two wavelengths among the n wavelengths from the DUT 60, and the rest of the n propagation wavelength characteristics may be characteristics of propagating propagation light including any number (1 to n) of wavelengths among the n wavelengths from the DUT 60.

For example, the propagation unit 110 may be composed of a material having variable optical characteristics, such as an optical switch or a voltage-controlled optical attenuator, and may be capable of switching n or more mutually different propagation wavelength characteristics by changing the optical characteristics.

For example, the optical power detection unit 120 is a light-receiving element such as a photodiode (PD), receives light from the DUT 60 or the calibration apparatus 50 via the propagation unit 110, and detects an optical power of the received light. More specifically, the optical power detection unit 120 outputs, to the optical power calculation unit 130, a photoelectric signal obtained by photoelectrically converting light received from the DUT 60 or the calibration apparatus 50 via the propagation unit 110.

The optical power detection unit 120 may have wavelength dependency in which it cannot detect an optical power for each of a plurality of wavelengths included in received light but detects an optical power for all wavelengths. Alternatively or additionally, the optical power detection unit 120 may have wavelength dependency in which it outputs a photoelectric signal having relatively large or small intensity with respect to a specific wavelength among a plurality of wavelengths included in the received light.

As an example, the optical power detection unit 120 detects optical powers of n beams of propagation light, which are based on the input light from the DUT 60, propagated with the n propagation wavelength characteristics from the propagation unit 110. More specifically, when the propagation unit 110 receives the input light from the DUT 60 n times, the optical power detection unit 120 receives propagation light propagated with a different propagation wavelength characteristic n times, and sequentially detects an optical power of each of n beams of propagation light. Note that the optical power detection unit 120 may detect optical powers of p beams of propagation light propagated from the propagation unit 110 with p (p is a natural number other than n) propagation wavelength characteristics. Note that the optical power of the propagation light detected by the optical power detection unit 120 may be an integrated value of optical powers of one or more wavelengths included in the propagation light.

The optical power calculation unit 130 corrects the wavelength dependency of the optical power detection unit 120 by using a plurality of propagation wavelength characteristics of the propagation unit 110, thereby calculating, from optical powers of a plurality of beams of propagation light detected by the optical power detection unit 120, each optical power of a plurality of wavelengths included in the input light from which the plurality of beams of propagation light are originated. A number of beams of the propagation light and a number of the propagation wavelength characteristics are equal to or larger than a number of the wavelengths included in the input light.

As an example, from the optical powers of the n beams of propagation light detected by the optical power detection unit 120, the optical power calculation unit 130 calculates an optical power for each of the n wavelengths included in the input light from the DUT 60, based on the n propagation wavelength characteristics of the propagation unit 110. From the optical powers of the n beams of propagation light, the optical power calculation unit 130 of the present embodiment back-calculates the optical power for each of the n wavelengths based on the n propagation wavelength characteristics.

In the present embodiment, as described above, the n propagation wavelength characteristics of the propagation unit 110 are identified in advance by using the reference input light, from the calibration apparatus 50, for each of the n wavelengths each having a known optical power. More specifically, the optical power calculation unit 130 calculates the n propagation wavelength characteristics of the propagation unit 110 in advance by using setting information of the wavelength and the optical power of each reference input light input from the setting instruction unit 170 and an optical power detection value of each reference propagation light input from the optical power detection unit 120 for each reference input light. The optical power calculation unit 130 may store transfer functions of respective calculated propagation wavelength characteristics, for example, a matrix, simultaneous equations, or the like in the storage unit 140.

The optical power calculation unit 130 may read transfer functions representing the n propagation wavelength characteristics from the storage unit 140 and back-calculate, from the optical powers of the n beams of propagation light, the optical power for each of the n wavelengths included in the input light from the DUT 60 by using the transfer functions. The optical power calculation unit 130 outputs a calculation result to the determination unit 150.

Note that, instead of the optical power calculation unit 130 identifying in advance the transfer functions representing the n propagation wavelength characteristics and storing them in the storage unit 140, an apparatus other than the test apparatus 100 may identify in advance transfer functions representing a large number of propagation wavelength characteristics for all wavelengths within a range that can be assumed as light emission wavelengths of various devices under test and store the transfer functions in the storage unit 140 of the test apparatus 100. In this case, the transfer functions representing the large number of propagation wavelength characteristics may be stored in the storage unit 140 at a manufacturing stage of the test apparatus 100 or after the test apparatus 100 is shipped. In this case, the optical power calculation unit 130 may selectively read the transfer functions representing the n propagation wavelength characteristics related to n wavelengths corresponding to the DUT 60, from the transfer functions representing the large number of propagation wavelength characteristics stored in the storage unit 140.

As an example, the optical power calculation unit 130 of the present embodiment also grasps a situation of optical power detection by the optical power detection unit 120 via the propagation unit 110, based on time schedule indicating an operation timing of each configuration of the test apparatus 100, the calibration apparatus 50, and the DUT 60. More specifically, according to the time schedule, the optical power calculation unit 130 may recognize a light emission method including light emission timings of the calibration apparatus 50 and the DUT 60 which are subject to open-loop control by the setting instruction unit 170, and the like.

Note that the optical power calculation unit 130 may receive the optical power detection value as a feedback signal from the optical power detection unit 120 to perform feedback control on setting and switching of the propagation wavelength characteristics of the propagation unit 110 by itself, thereby grasping the situation of the optical power detection by the optical power detection unit 120 via the propagation unit 110. In this case, the optical power calculation unit 130 may further receive the optical power detection value as the feedback signal from the optical power detection unit 120 to perform feedback control on the calibration apparatus 50 and the DUT 60 by itself, thereby grasping the light emission method including the light emission timing of the calibration apparatus 50 and the DUT 60, and the like.

The determination unit 150 determines the pass/fail of the DUT 60 based on the optical power, which is calculated by the optical power calculation unit 130, for each of the n wavelengths corresponding to the DUT 60. The determination unit 150 may hold a threshold related to the optical power for each of the n wavelengths, and when it is determined that each of all the optical powers for the n wavelengths included in the input light from the DUT 60 is equal to or greater than the threshold, may determine that the DUT 60 is a non-defective product.

The input unit 160 is a user interface, and receives each of the n wavelengths included in the DUT 60 from a user. The input unit 160 outputs the input n wavelengths to the setting instruction unit 170.

The setting instruction unit 170 receives, from the input unit 160, n wavelengths as wavelengths to be included in the reference input light. The setting instruction unit 170 instructs the calibration apparatus 50 to set the n wavelengths included in the reference input light and the optical power of each wavelength. The setting instruction unit 170 also outputs the setting information instructed to the calibration apparatus 50 to the optical power calculation unit 130.

As an example, the setting instruction unit 170 also creates the above-described time schedule indicating the operation timing of each configuration of the test apparatus 100, the calibration apparatus 50, and the DUT 60, and outputs the time schedule to the propagation unit 110, the optical power calculation unit 130, the calibration apparatus 50, and the DUT 60. More specifically, the setting instruction unit 170 performs open-loop control on setting and switching of the propagation wavelength characteristics of the propagation unit 110, based on the time schedule. The setting instruction unit 170 also outputs the time schedule to the optical power calculation unit 130, and performs open-loop control on the light emission method including the light emission timings of the calibration apparatus 50 and the DUT 60, and the like according to the time schedule.

Note that instead of receiving the information of the n wavelengths corresponding to the DUT 60 from the user via the input unit 160, the test apparatus 100 may identify the n wavelengths included in the light by using a spectrometer or the like to analyze wavelengths of light emitted from the DUT 60. In this case, the test apparatus 100 may not include the input unit 160, and may cause the setting instruction unit 170 to acquire information of the identified n wavelengths.

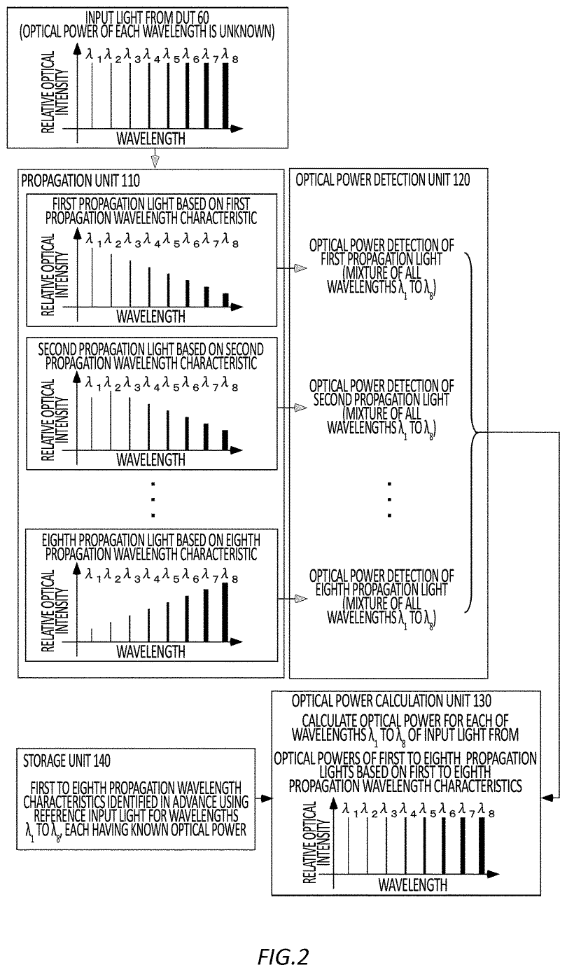

FIG. 2 is a diagram for schematically describing a method of detecting the optical power of each of the n wavelengths included in the input light from the DUT 60 by the test apparatus 100 according to one embodiment. FIG. 2 illustrates, together with relative optical intensity, eight wavelengths λ₁ to λ₈ as an example of the n wavelengths included in the input light from the DUT 60. In the example of FIG. 2, for the purpose of simplification of description, it is assumed that eight wavelengths λ₁ to λ₈ having a same optical power and equal intervals to adjacent wavelengths are included in the input light from the DUT 60.

As an example, in order to detect an unknown optical power of each of the eight wavelengths λ₁ to λ₈ included in the input light from the DUT 60, the test apparatus 100 inputs the input light from the DUT 60 to the propagation unit 110 eight times while switching eight propagation wavelength characteristics of the propagation unit 110. As an example, the eight propagation wavelength characteristics of the propagation unit 110 are identified in advance by using reference input light for each wavelength of λ₁ to λ₈ each having a known optical power, and transfer functions representing the eight propagation wavelength characteristics are stored in advance in the storage unit 140.

When the input light including the eight wavelengths λ₁ to λ₈ is input, the propagation unit 110 outputs propagation light having a different wavelength distribution according to a propagation wavelength characteristic set by the setting instruction unit 170 among the eight propagation wavelength characteristics. In other words, the wavelength distribution of the input light including the eight wavelengths λ₁ to λ₈ is changed to a different wavelength distribution according to each of the eight propagation wavelength characteristics of the propagation unit 110. For example, a peak wavelength in the wavelength distribution of the input light can be swept by sequentially switching the eight propagation wavelength characteristics of the propagation unit 110.

Thus, when the input light from the DUT 60 is input to the propagation unit 110 eight times while switching the eight propagation wavelength characteristics of the propagation unit 110, the wavelength distributions of eight beams of the propagation light output from the propagation unit 110 are mutually different. For example, when the propagation unit 110 is set to a first propagation wavelength characteristic, the wavelength distribution of the input light including the eight wavelengths λ₁ to λ₈ is changed to a first wavelength distribution different from the wavelength distribution of the input light by the propagation unit 110. When the propagation unit 110 is set to a second propagation wavelength characteristic, the wavelength distribution of the input light is changed to a second wavelength distribution different from the wavelength distribution of the input light and the first wavelength distribution by the propagation unit 110.

Here, as described above, the mutually different propagation wavelength characteristics in the propagation unit 110 are intended to be propagation wavelength characteristics independent of each other. The n propagation wavelength characteristics of the propagation unit 110 may be, for example, characteristics, each of which maintains or amplifies only optical powers of one or more distinct wavelengths among the n wavelengths and attenuates optical powers of remaining wavelengths. Specifically, one of the n propagation wavelength characteristics may be a characteristic of outputting propagation light having a wavelength distribution in which only an optical power of a first wavelength among the n wavelengths is maintained and optical powers of remaining wavelengths are attenuated, and another one of the n propagation wavelength characteristics may be a characteristic of outputting propagation light having a wavelength distribution in which only optical powers of a second wavelength and a third wavelength among the n wavelengths are maintained and optical powers of remaining wavelengths are attenuated. Alternatively or additionally, the n propagation wavelength characteristics of the propagation unit 110 may be, for example, characteristics, each of which maintains only optical powers of a plurality of distinct wavelengths among the n wavelengths and sets optical powers of remaining wavelengths to zero or each of which sets only an optical power of one distinct wavelength among the n wavelengths to zero and maintains optical powers of remaining wavelengths. Specifically, one of the n propagation wavelength characteristics may be a characteristic of outputting propagation light having a wavelength distribution in which only optical powers of the first wavelength and the second wavelength among the n wavelengths are maintained and optical powers of remaining wavelengths are set to zero, and another one of the n propagation wavelength characteristics may be a characteristic of outputting propagation light having a wavelength distribution in which only optical powers of the second wavelength and the third wavelength among the n wavelengths are maintained and optical powers of remaining wavelengths are set to zero.

FIG. 2 illustrates, as an example, a case where the eight propagation wavelength characteristics of the propagation unit 110 are characteristics, each of which maintains only an optical power of one distinct wavelength among the eight wavelengths λ₁ to λ₈, and attenuates optical powers of remaining wavelengths more greatly as a wavelength interval with the one wavelength is wider. Specifically, for example, the first propagation wavelength characteristic is a characteristic of outputting first propagation light having a wavelength distribution in which only an optical power of the wavelength λ₁ among the eight wavelengths λ₁ to λ₈ is maintained and optical powers of the remaining wavelengths λ₂ to λ₈ are attenuated gradually and greatly in order of the wavelengths λ₂ to λ₈. For example, the second propagation wavelength characteristic is a characteristic of outputting second propagation light having a wavelength distribution in which only the optical power of the wavelength λ₂ among the eight wavelengths λ₁ to λ₈ is maintained and optical powers of remaining wavelengths λ₁ and λ₃ to λ₈ are attenuated at a similar ratio for the wavelengths λ₁ and λ₃, and attenuated gradually and greatly in order of the wavelengths λ₃ to λ₈. For example, an eighth propagation wavelength characteristic is a characteristic of outputting eighth propagation light having a wavelength distribution in which only an optical power of the wavelength λ₈ among the eight wavelengths λ₁ to λ₈ is maintained and optical powers of the remaining wavelengths λ₁ to λ₇ is attenuated gradually and greatly in order of the wavelengths λ₇ to λ₁. In FIG. 2, in order to simply distinguish the eight wavelengths λ₁ to λ₈, a line thickness of a graph of the relative optical intensity is increased gradually in order of the wavelengths λ₁ to λ₈, and the same applies to subsequent drawings, and redundant description will be omitted.

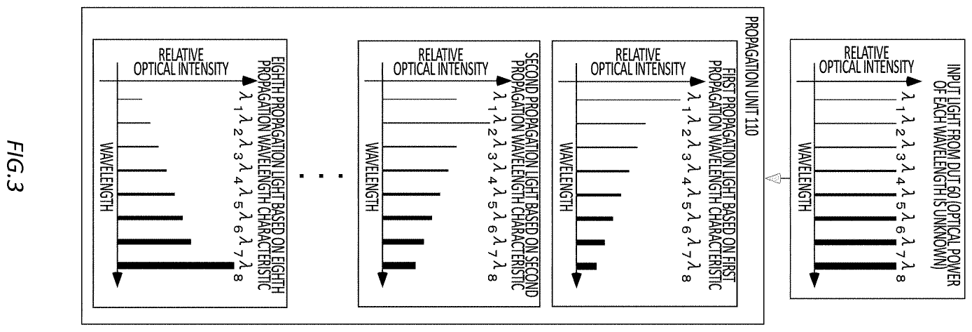

FIGS. 3 to 6 are diagrams for describing examples of the n propagation wavelength characteristics of the propagation unit 110 in the test apparatus 100 according to one embodiment. As another example of the eight propagation wavelength characteristics of the propagation unit 110 illustrated in FIG. 2, FIG. 3 illustrates a case where the eight propagation wavelength characteristics are characteristics, each of which amplifies only an optical power of one distinct wavelength among the eight wavelengths λ₁ to λ₈, and attenuates optical powers of remaining wavelengths more greatly as a wavelength interval with the one wavelength is wider. Specifically, for example, the first propagation wavelength characteristic is a characteristic of outputting first propagation light having a wavelength distribution in which only the optical power of the wavelength λ₁ among the eight wavelengths λ₁ to λ₈ is amplified and the optical powers of the remaining wavelengths λ₂ to λ₈ are attenuated gradually and greatly in order of the wavelengths λ₂ to λ₈. For example, the second propagation wavelength characteristic is a characteristic of outputting second propagation light having a wavelength distribution in which only the optical power of the wavelength λ₂ among the eight wavelengths λ₁ to λ₈ is amplified and the optical powers of the remaining wavelengths λ₁ and λ₃ to λ₈ are attenuated at a similar ratio for the wavelengths λ₁ and λ₃ and attenuated gradually and greatly in order of the wavelengths λ₃ to λ₈. For example, the eighth propagation wavelength characteristic is a characteristic of outputting eighth propagation light having a wavelength distribution in which only the optical power of the wavelength λ₈ among the eight wavelengths λ₁ to λ₈ is amplified and the optical powers of the remaining wavelengths λ₁ to λ₇ are attenuated gradually and greatly in order of the wavelengths λ₇ to λ₁.

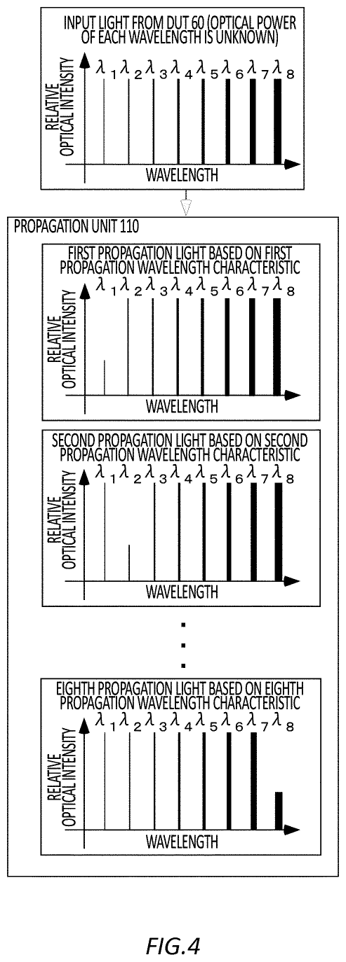

FIG. 4 illustrates, as another example, a case where the eight propagation wavelength characteristics of the propagation unit 110 are characteristics, each of which attenuates only the optical power of one distinct wavelength among the eight wavelengths λ₁ to λ₈ and amplifies the optical powers of the remaining wavelengths at a similar ratio. Specifically, for example, the first propagation wavelength characteristic is a characteristic of outputting first propagation light having a wavelength distribution in which only the optical power of the wavelength λ₁ among the eight wavelengths λ₁ to λ₈ is attenuated and the optical powers of the remaining wavelengths λ₂ to λ₈ are amplified at a similar ratio. For example, the second propagation wavelength characteristic is a characteristic of outputting second propagation light having a wavelength distribution in which only the optical power of the wavelength λ₂ among the eight wavelengths λ₁ to λ₈ is attenuated and the optical powers of the remaining wavelengths λ₁ and λ₃ to λ₈ are amplified at a similar ratio. For example, the eighth propagation wavelength characteristic is a characteristic of outputting eighth propagation light having a wavelength distribution in which only the optical power of the wavelength λ₈ among the eight wavelengths λ₁ to λ₈ is attenuated and the optical powers of the remaining wavelengths λ₁ to λ₇ are amplified at a similar ratio.

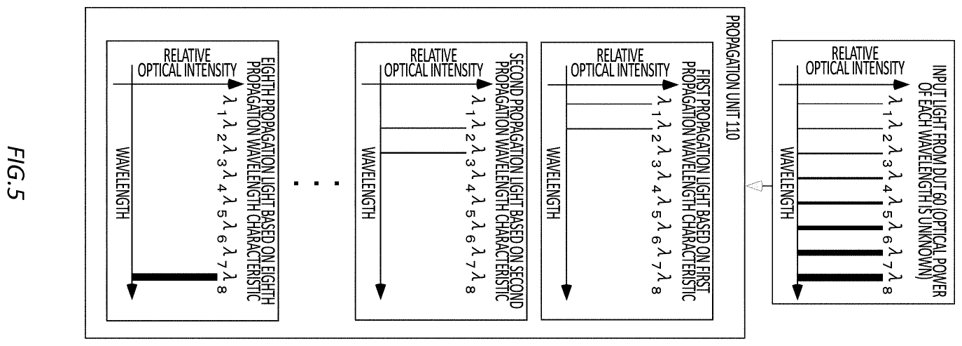

FIG. 5 illustrates, as another example, a case where at least one of the eight propagation wavelength characteristics of the propagation unit 110 is a characteristic, each of which maintains only optical powers of two distinct wavelengths among the eight wavelengths λ₁ to λ₈ and sets optical powers of remaining wavelengths to zero. Specifically, for example, the first propagation wavelength characteristic is a characteristic of outputting first propagation light having a wavelength distribution in which only optical powers of the wavelengths λ₁ and λ₂ among the eight wavelengths λ₁ to λ₈ are maintained and optical powers of the remaining wavelengths λ₃ to λ₈ are set to zero. For example, the second propagation wavelength characteristic is a characteristic of outputting second propagation light having a wavelength distribution in which only optical powers of the wavelength λ₂ and the wavelength λ₃ among the eight wavelengths λ₁ to λ₈ are maintained and optical powers of the remaining wavelengths λ₁ and λ₄ to λ₈ are set to zero. For example, the eighth propagation wavelength characteristic is a characteristic of outputting eighth propagation light having a wavelength distribution in which only the optical power of the wavelength λ₈ among the eight wavelengths λ₁ to λ₈ is maintained and the optical powers of the remaining wavelengths λ₁ to λ₇ are set to zero.

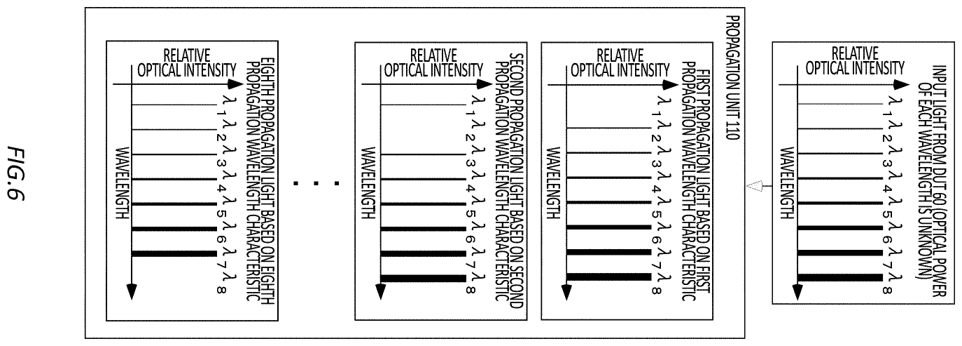

FIG. 6 illustrates, as an example, a case where the eight propagation wavelength characteristics of the propagation unit 110 are characteristics, each of which sets only the optical power of one distinct wavelength among the eight wavelengths λ₁ to λ₈ to zero and maintains the optical powers of the remaining wavelengths. Specifically, for example, the first propagation wavelength characteristic is a characteristic of outputting first propagation light having a wavelength distribution in which only the optical power of the wavelength λ₁ among the eight wavelengths λ₁ to λ₈ is set to zero and the optical powers of the remaining wavelengths λ₂ to λ₈ are maintained. For example, the second propagation wavelength characteristic is a characteristic of outputting second propagation light having a wavelength distribution in which only the optical power of the wavelength λ₂ among the eight wavelengths λ₁ to λ₈ is set to zero and the optical powers of the remaining wavelengths λ₁ and λ₃ to λ₈ are maintained. For example, the eighth propagation wavelength characteristic is a characteristic of outputting eighth propagation light having a wavelength distribution in which only the optical power of the wavelength λ₈ among the eight wavelengths λ₁ to λ₈ is set to zero and the optical powers of the remaining wavelengths λ₁ to λ₇ are maintained.

As described above, the propagation unit 110 capable of propagating light with n or more switchable and mutually different propagation wavelength characteristics may be composed of a material having variable optical characteristics, such as an optical switch or a voltage-controlled optical attenuator, for example. As another example of the material, a tunable filter that transmits only light of several adjacent wavelengths among input light including a plurality of wavelengths and filters light of remaining wavelengths, a reflecting element that changes and reflects optical powers of one or more wavelengths among input light including a plurality of wavelengths, or the like may be used. The propagation unit 110 may be capable of switching n or more propagation wavelength characteristics by controlling at least one of a temperature, a voltage, a current, a charge, a magnetic flux, or a pressure applied to such a material having variable optical characteristics. Alternatively, the propagation unit 110 may be capable of switching the n or more propagation wavelength characteristics by using at least one of a servomotor, a piezoelectric element, or a bimetal to change a physical dimension of an optical path of propagation light, for example, an optical path length. Alternatively, the propagation unit 110 may be capable of switching the n or more propagation wavelength characteristics by switching n or more propagation apparatuses that propagate light with mutually different propagation wavelength characteristics.

The optical power detection unit 120 sequentially detects each optical power of the first to eighth propagation lights, and outputs each detected optical power to the optical power calculation unit 130. That is, the optical power detection unit 120 outputs, to the optical power calculation unit 130, a photoelectric signal obtained by photoelectrically converting each of the received first to eighth propagation lights. Note that any of the first to eighth propagation lights is all-wavelength mixed light including all the eight wavelengths λ₁ to λ₈.

The optical power calculation unit 130 calculates an optical power for each of the wavelengths λ₁ to λ₈ of the input light from the optical powers of the first to eighth propagation lights, based on the first to eighth propagation wavelength characteristics. The optical power calculation unit 130 reads transfer functions representing the eight propagation wavelength characteristics from the storage unit 140, and calculates the optical power for each of the wavelengths λ₁ to λ₈ of the input light from the optical powers of the first to eighth propagation lights by using the transfer functions.

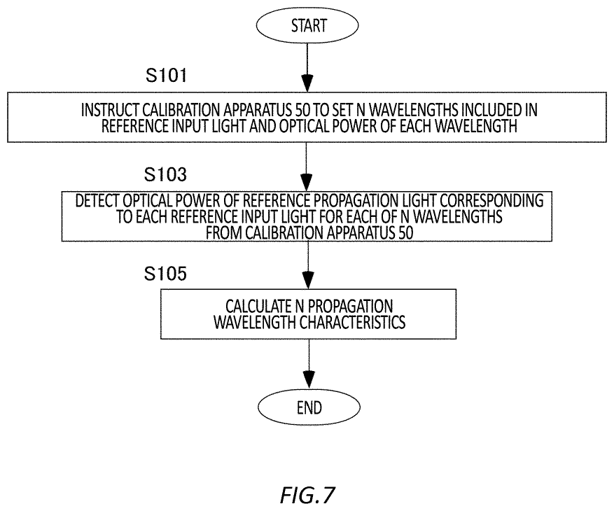

FIG. 7 is a flowchart illustrating an example of an operation flow of calculating the first to eighth propagation wavelength characteristics by the test apparatus 100 according to one embodiment. As an example, the operation flow of FIG. 7 starts when the test apparatus 100 receives the n wavelengths included in the DUT 60 from the user.

The test apparatus 100 instructs the calibration apparatus 50 to set the n wavelengths included in the reference input light and the optical power of each wavelength according to the n wavelengths input from the user (step S101). In step S101, as an example, the test apparatus 100 transmits, to the calibration apparatus 50, a time schedule indicating a light emission timing of each reference input light to perform open-loop control on the calibration apparatus 50.

The test apparatus 100 detects the optical power of the reference propagation light corresponding to each reference input light for each of the n wavelengths from the calibration apparatus 50 (step S103). More specifically, for example, the test apparatus 100 sequentially receives n beams of reference input light having mutually different wavelengths from the calibration apparatus 50 in a state where one propagation wavelength characteristic among the n propagation wavelength characteristics of the propagation unit 110 is set by controlling a voltage applied to the propagation unit 110. The optical powers of the n beams of reference input light may be the same as or different from each other. The test apparatus 100 detects the optical power changed due to the one propagation wavelength characteristic in a process in which the reference input light propagates through the propagation unit 110 of the test apparatus 100. The test apparatus 100 acquires n optical power detection values for the one propagation wavelength characteristic. As an example, the test apparatus 100 acquires n optical power detection values for each propagation wavelength characteristic by sequentially switching the n propagation wavelength characteristics of the propagation unit 110 according to the above-described time schedule. Thus, the test apparatus 100 acquires n×n optical power detection values of n×n beams of reference propagation light in total for the n propagation wavelength characteristics.

The test apparatus 100 calculates the n propagation wavelength characteristics of the propagation unit 110 by the setting information of the wavelength and the optical power of each reference input light set in step S101 and the n×n optical power detection values detected in step S103 (step S105).

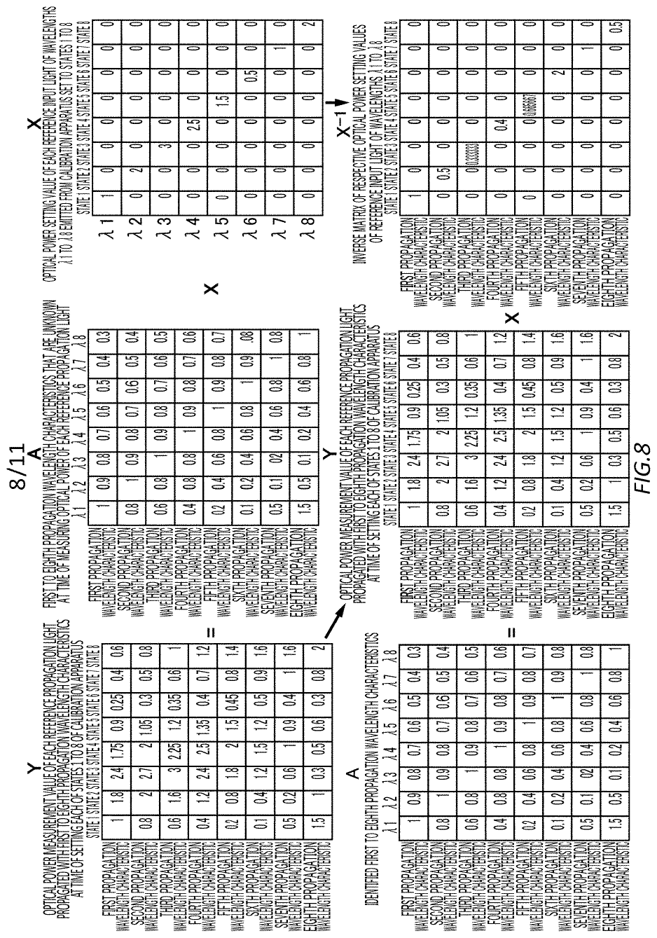

FIG. 8 is a diagram for describing an example of a method of calculating the first to eighth propagation wavelength characteristics by the test apparatus 100 according to one embodiment. On a left side of FIG. 8, a first matrix X of 8 rows and 8 columns representing “the optical power setting value for each reference input light of the wavelengths λ₁ to λ₈ emitted from the calibration apparatus 50 set to States 1 to 8”, a second matrix A of 8 rows and 8 columns representing “first to eighth propagation wavelength characteristics which are unknown at the time of measuring the optical power of each reference propagation light”, and a third matrix Y of 8 rows and 8 columns representing “the optical power measurement value of each reference propagation light propagated with first to eighth propagation wavelength characteristics at the time of setting each of States 1 to 8 of the calibration apparatus 50” are illustrated in order from the top. As illustrated on the left side of FIG. 8, a product of the first matrix X and the second matrix A is equal to the third matrix Y, that is, an equation of Y=A·X is established.

In the first matrix X, first to eighth columns indicate States 1 to 8 corresponding to the eight reference input lights output from the calibration apparatus 50 in order, and first to eighth rows indicate the wavelengths λ₁ to λ₈ of the reference input light in order. In the second matrix A, first to eighth columns sequentially indicate the wavelengths λ₁ to λ₈ of the propagation light, respectively, and first to eighth rows sequentially indicate the first to eighth propagation wavelength characteristics of the propagation unit 110. In the third matrix Y, first to eighth columns indicate States 1 to 8 of the calibration apparatus 50 in order, and first to eighth rows indicate the first to eighth propagation wavelength characteristics of the propagation unit 110 in order.

The first matrix X is an example of the setting information transmitted from the setting instruction unit 170 to the calibration apparatus 50, and is an example of the instruction content of step S101 in FIG. 7. The second matrix A is an example of the above-described transfer functions representing the n propagation wavelength characteristics calculated by the optical power calculation unit 130, and is an example of the calculation result in step S105 in FIG. 7. The third matrix Y is an example of the optical powers of the n×n beams of reference propagation light, which are propagated with the n propagation wavelength characteristics for each of n wavelengths from the propagation unit 110 to which the reference input light for each of n wavelengths is input, the optical powers being detected by the optical power detection unit 120, and is an example of the n×n optical power detection values of the n×n beams of reference propagation light detected in step S103 in FIG. 7.

As in 8 rows×8 columns=64 components in the second matrix A in FIG. 8, the n propagation wavelength characteristics of the propagation unit 110 may include the n propagation wavelength characteristic elements for each of the n wavelengths, so that a total of n×n propagation wavelength characteristic elements may be included. An object of the optical power calculation unit 130 is to calculate the n×n propagation wavelength characteristic elements that are unknown at the time of measuring the optical power of each reference propagation light. The optical power calculation unit 130 may calculate the n×n propagation wavelength characteristic elements like the second matrix A in FIG. 8, based on the known optical power of each reference input light for each of the n wavelengths like the first matrix X in FIG. 8 and the optical powers of the n×n beams of reference propagation light like the third matrix Y in FIG. 8. The optical power calculation unit 130 may calculate the n×n propagation wavelength characteristic elements to calculate the n propagation wavelength characteristics in advance.

Specifically, the optical power calculation unit 130 may acquire a vertical vector of a first column of the third matrix Y by vertically arranging optical power detection values of eight beams of reference propagation light obtained by sequentially switching the propagation unit 110 from the first propagation wavelength characteristic to the eighth propagation wavelength characteristic while the calibration apparatus 50 is set to State 1 and the reference input light having the wavelength λ₁ is output. The optical power calculation unit 130 may acquire respective vertical vectors of second to eighth columns of the third matrix Y by performing similar processing on States 2 to 8 of the calibration apparatus 50, thereby acquiring the third matrix Y. As illustrated in FIG. 8, the optical power calculation unit 130 may further calculate the second matrix A by calculating an inverse matrix X⁻¹ of the known first matrix X, multiplying both sides of Y=A·X from the right by the inverse matrix X⁻¹, and obtaining Equation 1 below, that is, may calculate the eight propagation wavelength characteristics of the propagation unit 110.

$$A = Y \cdot {X}^{- 1} \qquad ( Equation 1 )$$

Note that, as illustrated in the first matrix X of FIG. 8, in the present embodiment, each of the n beams of reference input light for each of the n wavelengths includes one wavelength, but instead, each of the n beams of reference input light for each of the n wavelengths may include a plurality of wavelengths as long as the wavelength distributions of respective beams of reference input light are distinct and independent of each other.

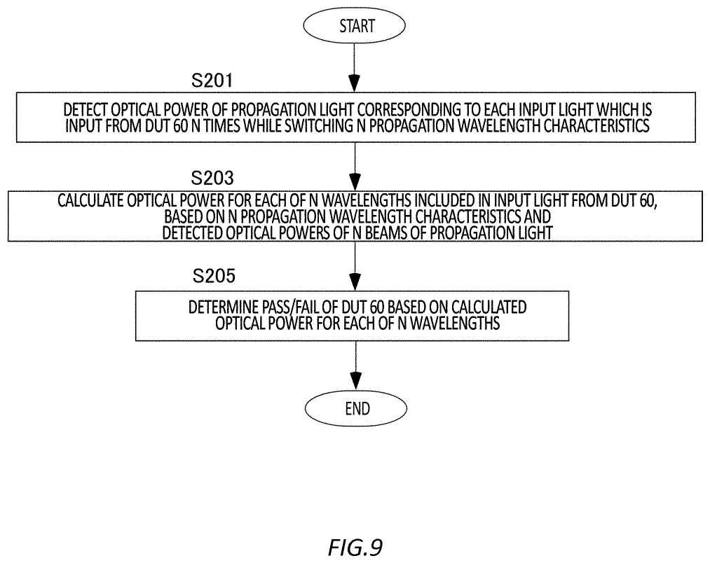

FIG. 9 is a flowchart illustrating an example of an operation flow of detecting the optical power of each of the n wavelengths included in input light from the DUT 60 by the test apparatus 100 according to one embodiment. As an example, the operation flow of FIG. 9 starts when the user arranges the DUT 60 at a place where the calibration apparatus 50 is arranged on an input side of the test apparatus 100 after the test apparatus 100 completes the operation flow of FIG. 7, and the test apparatus 100 and the DUT 60 are electrically connected so that a current or a voltage can be applied from the test apparatus 100 to the DUT 60.

The test apparatus 100 detects the optical power of the propagation light corresponding to each input light which is input from the DUT 60 n times while switching the n propagation wavelength characteristics (step S201). Specifically, in a state where one propagation wavelength characteristic among the n propagation wavelength characteristics of the propagation unit 110 is set by controlling the voltage applied to the propagation unit 110, the test apparatus 100 causes the propagation unit 110 to propagate the input light from the DUT 60 and causes the optical power detection unit 120 to receive the propagation light from the propagation unit 110. As an example, the test apparatus 100 transmits, to the DUT 60, a time schedule indicating a light emission timing of the input light to perform open-loop control on the DUT 60. As an example, the DUT 60 emits light according to the time schedule in a state where a current or voltage is applied from the test apparatus 100. The optical power detection unit 120 outputs, to the optical power calculation unit 130, a photoelectric signal obtained by photoelectrically converting the received propagation light. The test apparatus 100 sequentially switches the n propagation wavelength characteristics of the propagation unit 110 and repeats the same processing for all of the n propagation wavelength characteristics.

The test apparatus 100 calculates the optical power for each of the n wavelengths included in the input light from the DUT 60, based on the n propagation wavelength characteristics and the detected optical powers of the n beams of propagation light (step S203).

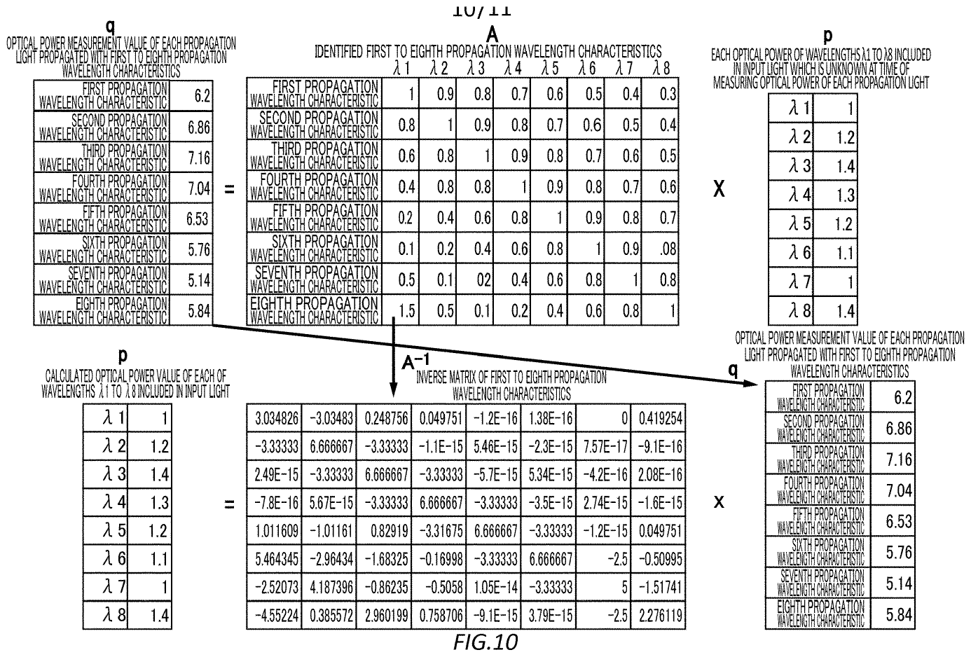

FIG. 10 is a diagram for describing an example of a method of calculating the optical power of each of the wavelengths λ₁ to λ₈ included in the input light from the DUT 60 by the test apparatus 100 according to one embodiment. On a left side of FIG. 10, a first vertical vector p of 8 rows and 1 column representing “each optical power of the wavelengths λ₁ to λ₈ included in the input light, which is unknown at the time of measuring the optical power of each propagation light”, a matrix A of 8 rows and 8 columns representing “the identified first to eighth propagation wavelength characteristics”, and a second vertical vector q of 8 rows and 1 column representing “the optical power measurement value of each propagation light propagated with the first to eighth propagation wavelength characteristics” are illustrated in order from the top. As illustrated on the left side of FIG. 9, a product of the first vertical vector p and the matrix A is equal to the second vertical vector q, that is, an equation q=A·p is established.

In the first vertical vector p, first to eighth rows sequentially indicate the wavelengths λ₁ to λ₈ included in the input light from the DUT 60. The matrix A is the same as the second matrix A in FIG. 8. In the second vertical vector q, first to eighth rows sequentially indicate the first to eighth propagation wavelength characteristics of the propagation unit 110.

The first vertical vector p is an example of the above-described optical power for each of the n wavelengths included in the input light from the DUT 60. Similarly to the second matrix A in FIG. 8, the matrix A is an example of the transfer functions representing the n propagation wavelength characteristics calculated by the optical power calculation unit 130, is an example of the calculation result in step S105 in FIG. 7, and is stored in, for example, the storage unit 140. The second vertical vector q is an example of the optical powers of the n beams of propagation light detected by the optical power detection unit 120 in step S201 of FIG. 9.

An object of the optical power calculation unit 130 is to calculate the optical power for each of the n wavelengths included in the input light from the DUT 60, such as the first vertical vector p of FIG. 10, which is unknown at the time of measuring the optical power of each propagation light. From the optical power of the n beams of propagation light detected by the optical power detection unit 120, such as the second vertical vector q in FIG. 10, the optical power calculation unit 130 may back-calculate the optical power for each of the n wavelengths included in the input light from the DUT 60, such as the first vertical vector p in FIG. 10, based on the n propagation wavelength characteristics such as the matrix A in FIG. 10.

Specifically, the optical power calculation unit 130 may acquire the second vertical vector q by vertically arranging the optical power detection values of the eight beams of propagation light obtained by sequentially switching the propagation unit 110 from the first propagation wavelength characteristic to the eighth propagation wavelength characteristic while the input light is output from the DUT 60. As illustrated in FIG. 10, the optical power calculation unit 130 may further calculate the first vertical vector p by calculating an inverse matrix A⁻¹ of the matrix A identified in advance, multiplying both sides of q=A·p from the left by the inverse matrix A⁻¹, and obtaining Equation 2 below, that is, may calculate each optical power of the wavelengths λ₁ to λ₈ included in the input light from the DUT 60.

$$p = {A}^{- 1} \cdot q \qquad ( Equation 2 )$$

Note that the optical power calculation unit 130 may calculate the matrix A in step S105 in FIG. 7, then calculate the inverse matrix A⁻¹ of the matrix A, and store it in the storage unit 140, and in this case, in step S203 in FIG. 9, the inverse matrix A⁻¹ of the matrix A may be read from the storage unit 140 to calculate the first vertical vector p.

Referring to FIG. 9 again, following step S203, the test apparatus 100 determines the pass/fail of the DUT 60 based on the calculated optical power for each of the n wavelengths (step S205), and the flow ends. Specifically, the test apparatus 100 may compare the calculated optical power for each of the n wavelengths with a threshold related to the optical power for each of the n wavelengths, and when it is determined that all the calculated optical powers for the n wavelengths are equal to or greater than corresponding thresholds, determine that the DUT 60 is a non-defective product. The test apparatus 100 may further exclude the DUT 60 determined to have failed, from a target of the subsequent test.

As a first comparative example with the test apparatus 100 according to one embodiment described above, an apparatus is assumed in which a spectroscope such as a prism is used to spatially separate light of a plurality of wavelengths included in input light from a device under test, light of one wavelength is received by an optical power detector, and the light to be received by the optical power detector is selected by rotationally driving the spectroscope. As a second comparative example, an apparatus is assumed in which a tunable filter that transmits only light of one selected wavelength among light of a plurality of wavelengths included in input light from a device under test is used, light of one wavelength is received by an optical power detector, and the light to be received by the optical power detector is selected by controlling the tunable filter.

The spectroscope capable of spatially separating light of a plurality of wavelengths for each wavelength in the first comparative example and the tunable filter that transmits only light of one selected wavelength among light of a plurality of wavelengths in the second comparative example are more expensive than constituent materials of the propagation unit 110 of the test apparatus 100 according to the present embodiment, for example, constituent materials having variable optical characteristics such as an optical switch and a voltage-controlled optical attenuator, constituent materials capable of changing physical dimensions of an optical path of propagation light such as a servomotor, a piezoelectric element, and a bimetal, a plurality of propagation apparatuses that propagate light with mutually different propagation wavelength characteristics, and the like. The test apparatus 100 according to the present embodiment includes the propagation unit 110 that can switch n or more mutually different propagation wavelength characteristics with respect to input light including n wavelengths from the device under test and propagates the input light with n propagation wavelength characteristics, the optical power detection unit 120 that detects optical powers of n beams of propagation light propagated with the n propagation wavelength characteristics from the propagation unit 110, and the optical power calculation unit 130 that calculates an optical power for each of the n wavelengths included in the input light, from the optical powers of the n beams of propagation light detected by the optical power detection unit 120, based on the n propagation wavelength characteristics. According to the test apparatus 100 of the present embodiment having such a configuration, it is possible to calculate the optical power for each of the n wavelengths included in the input light with an inexpensive apparatus configuration as compared with the first comparative example and the second comparative example.

In the embodiment described above, in order to calculate in advance the n propagation wavelength characteristics of the propagation unit 110 corresponding to the n wavelengths included in the input light from the DUT 60, the test apparatus 100 is configured to detect the optical power of each reference propagation light which is based on each reference input light of n wavelengths same as the n wavelengths. Instead of the configuration of detecting the optical power of each reference propagation light which is based on each reference input light of n wavelengths same as the n wavelengths, the test apparatus 100 may detect the optical power of each reference propagation light which is based on each reference input light of a plurality of wavelengths close to the n wavelengths, and use a plurality of optical power detection values thereof to perform interpolation on the optical power of each reference propagation light which is based on each reference input light of wavelengths same as the n wavelengths, thereby calculating in advance the n propagation wavelength characteristics of the propagation unit 110. The interpolation may be, for example, linear interpolation or averaging.

As a specific example, first, the wavelengths of the n beams of reference input light include wavelengths other than the n wavelengths included in the input light from the DUT 60, and a wavelength band of the n beams of reference input light is assumed to at least partially overlap a wavelength band of the n wavelengths included in the input light. In this case, the optical power calculation unit 130 may calculate the n×n propagation wavelength characteristic elements based on each known optical power of the reference input light for each of the n wavelengths and the optical powers of the n×n beams of reference propagation light propagated with the n propagation wavelength characteristics for each of the n wavelengths from the propagation unit 110 to which the reference input light for each of the n wavelengths is input, the optical powers being detected by the optical power detection unit 120. The optical power calculation unit 130 may calculate the n propagation wavelength characteristics in advance by using the calculated n×n propagation wavelength characteristic elements to interpolate the n×n propagation wavelength characteristic elements corresponding to the n wavelengths included in the input light from the DUT 60.

In the embodiment described above, in order to calculate in advance the n propagation wavelength characteristics of the propagation unit 110 corresponding to the n wavelengths included in the input light from the DUT 60, the test apparatus 100 is configured to detect the optical power of each reference propagation light which is based on each reference input light of the n wavelengths same as the n wavelengths. Instead of the configuration of detecting the optical power of each reference propagation light which is based on each reference input light of n wavelengths same as the n wavelengths, the test apparatus 100 may detect the optical power of each reference propagation light which is based on each reference input light of a larger number of wavelengths including the n wavelengths or each reference propagation light which is based on each reference input light of a smaller number of wavelengths including some of the n wavelengths. When the optical power of each reference propagation light which is based on each reference input light of a smaller number of wavelengths than that of the n wavelengths is detected, as described above, the n propagation wavelength characteristics of the propagation unit 110 may be calculated in advance by using a plurality of optical power detection values thereof to interpolate the optical power of each reference propagation light which is based on each reference input light of wavelengths same as the n wavelengths.

As a specific example, the optical power calculation unit 130 may back-calculate the optical power of each of the n wavelengths included in the input light from the DUT 60, from the optical powers of the n beams of propagation light, based on the n propagation wavelength characteristics identified in advance by using reference input light of each of m (m≠n) wavelengths each having a known optical power. In this case, the m wavelengths may include wavelengths other than the n wavelengths, and in this case, a wavelength band of the m wavelengths is assumed to at least partially overlap the wavelength band of the n wavelengths. As a more specific example, the optical power calculation unit 130 may store an inverse matrix of m×m (m>n) in the storage unit 140, and use an n×n submatrix thereof as the n propagation wavelength characteristics.

In this case, the optical power calculation unit 130 may calculate m×n propagation wavelength characteristic elements based on each known optical power of reference input light for each of the m wavelengths and optical powers of m×n beams of reference propagation light propagated with the n propagation wavelength characteristics for each of the m wavelengths from the propagation unit 110 to which the reference input light for each of the m wavelengths is input, the optical powers being detected by the optical power detection unit 120. The optical power calculation unit 130 may calculate the n propagation wavelength characteristics in advance by using the calculated m×n propagation wavelength characteristic elements to interpolate the n×n propagation wavelength characteristic elements corresponding to the n wavelengths included in the input light from the DUT 60.

In the embodiment described above, several examples of the n propagation wavelength characteristics in the propagation unit 110 of the test apparatus 100 are illustrated in FIGS. 2 to 6. Instead of or in addition to this, the n propagation wavelength characteristics of the propagation unit 110 may be characteristics in that a ratio of attenuating the optical power is increased or decreased in order from a smallest wavelength to a largest wavelength among the n wavelengths included in the input light, and a degree of increase or decrease of the ratio may be increased or decreased in order from a first propagation wavelength characteristic to an nth propagation wavelength characteristic. For example, when the n propagation wavelength characteristics of the propagation unit 110 are characteristics in which the ratio of attenuating the optical power is increased in order from the smallest wavelength to the largest wavelength among the n wavelengths included in the input light, and the ratio is increased in order from the first propagation wavelength characteristic to the nth propagation wavelength characteristic, a degree of rightward downward slope may be reduced in the wavelength distribution of the propagation light propagated with the first propagation wavelength characteristic compared to the wavelength distribution of the propagation light propagated with the second propagation wavelength characteristic. For example, when the n propagation wavelength characteristics of the propagation unit 110 are characteristics in which the ratio of attenuating the optical power is decreased in order from the smallest wavelength to the largest wavelength among the n wavelengths included in the input light, and the ratio is decreased in order from the first propagation wavelength characteristic to the nth propagation wavelength characteristic, a degree of leftward downward slope may be increased in the wavelength distribution of the propagation light propagated with the first propagation wavelength characteristic compared to the wavelength distribution of the propagation light propagated with the second propagation wavelength characteristic.

Various embodiments of the present invention may be described with reference to flowcharts and block diagrams, where blocks may represent (1) stages of processes in which operations are executed or (2) sections of apparatuses responsible for executing operations. Certain stages and sections may be implemented by a dedicated circuit, a programmable circuit supplied together with computer-readable instructions stored on computer-readable media, and/or processors supplied together with computer-readable instructions stored on computer-readable media. The dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical operations, a memory element or the like such as a flip-flop, a register, a field programmable gate array (FPGA) and a programmable logic array (PLA), or the like.

A computer-readable medium may include any tangible device that can store instructions to be executed by a suitable device, and as a result, the computer-readable medium having instructions stored thereon includes a product including instructions that can be executed in order to create means for executing operations specified in the flowcharts or block diagrams. Examples of the computer-readable medium may include an electronic storage medium, a magnetic storage medium, an optical storage medium, an electromagnetic storage medium, a semiconductor storage medium, or the like. More specific examples of the computer-readable medium may include a FLOPPY (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a BLU-RAY® disk, a memory stick, an integrated circuit card, or the like.

The computer-readable instruction may include: an assembler instruction, an instruction-set-architecture (ISA) instruction; a machine instruction; a machine dependent instruction; a microcode; a firmware instruction; state-setting data; or either a source code or an object code described in any combination of one or more programming languages, including an object oriented programming language such as SMALLTALK (registered trademark), JAVA (registered trademark), C++, or the like, and a conventional procedural programming language such as a “C” programming language or a similar programming language.

The computer-readable instruction may be provided to a processor of a programmable data processing apparatus such as a computer, or to a programmable circuit, locally or via a local area network (LAN), wide area network (WAN) such as the Internet, or the like, to execute the computer-readable instructions in order to create means for performing operations specified in the flowcharts or block diagrams. Here, the computer may be a personal computer, or PC, a tablet computer, a smartphone, a work station, a server computer, a general-purpose computer, a special-purpose computer, or the like, or may be a computer system to which a plurality of computers are connected. Such computer system in which the plurality of computers are connected to each other is also called a distributed computing system, and is a computer in a broad sense. In the distributed computing system, the plurality of computers collectively execute the program by each of the plurality of computers executing a part of the program, and passing data during the execution of the program among the computers as needed.

Examples of the processor include a computer processor, a central processing unit (CPU), a processing unit, a microprocessor, a digital signal processor, a controller, a microcontroller, or the like. The computer may include a single processor or a plurality of processors. In a multiprocessor system including a plurality of processors, the plurality of processors collectively execute the program by each processor executing a portion of the program and passing data between the processors during program execution as needed. For example, in execution of multiple tasks, each of the plurality of processors may execute a portion of each task pieces by pieces by performing task-switching for each time slice. In this case, which portion of one program each processor is responsible for executing dynamically changes. Moreover, which portion of the program each of the plurality of processor is responsible for executing may be determined statically by multiprocessor-aware programming.

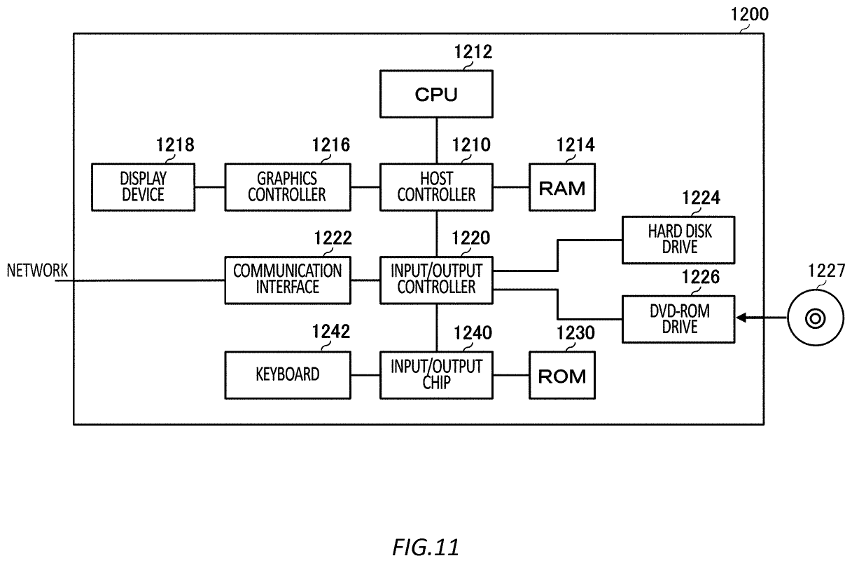

FIG. 11 illustrates an example of a computer 1200 in which a plurality of aspects of the present invention may be embodied wholly or partially. A program installed in the computer 1200 can cause the computer 1200 to function as an operation associated with the apparatuses according to the embodiments of the present invention or as one or more sections of the apparatuses, or can cause the operation or the one or more sections to be executed, and/or can cause the computer 1200 to execute a process according to the embodiments of the present invention or a stage of the process. Such a program may be executed by a CPU 1212 in order to cause the computer 1200 to execute particular operations associated with some or all of the blocks of flowcharts and block diagrams described in the present specification.

The computer 1200 according to the present embodiment includes the CPU 1212, an RAM 1214, a graphics controller 1216, and a display device 1218, which are mutually connected by a host controller 1210. The computer 1200 also includes input/output units such as a communication interface 1222, a hard disk drive 1224, a DVD-ROM drive 1226, and an IC card drive, which are connected to the host controller 1210 via an input/output controller 1220. The computer also includes legacy input/output units such as an ROM 1230 and a keyboard 1242, which are connected to the input/output controller 1220 via an input/output chip 1240.

The CPU 1212 operates according to programs stored in the ROM 1230 and the RAM 1214, thereby controlling each unit. The graphics controller 1216 acquires image data generated by the CPU 1212 on a frame buffer or the like provided in the RAM 1214 or in itself, and causes the image data to be displayed on a display device 1218.

The communication interface 1222 communicates with other electronic devices via a network. The hard disk drive 1224 stores programs and data which are used by the CPU 1212 within the computer 1200. The DVD-ROM drive 1226 reads the programs or the data from the DVD-ROM 1201, and provides the hard disk drive 1224 with the programs or the data via the RAM 1214. The IC card drive reads the programs and the data from the IC card, and/or writes the programs and the data to the IC card.

The ROM 1230 stores therein a boot program or the like that is executed by the computer 1200 at the time of activation, and/or a program which depends on the hardware of the computer 1200. The input/output chip 1240 may also connect various input/output units to the input/output controller 1220 via a parallel port, a serial port, a keyboard port, a mouse port, or the like.

A program is provided by computer-readable media such as the DVD-ROM 1201 or the IC card. The program is read from the computer-readable media, installed into the hard disk drive 1224, the RAM 1214, or the ROM 1230, which are also examples of computer-readable media, and performed by the CPU 1212. Information processing written in these programs is read by the computer 1200, and provides cooperation between the programs and the various types of hardware resources described above. The apparatus or method may be configured by implementing operations or processing of information according to use of the computer 1200.

For example, when communication is executed between the computer 1200 and an external device, the CPU 1212 may execute a communication program loaded onto the RAM 1214 to instruct communication processing to the communication interface 1222, based on the processing written in the communication program. The communication interface 1222, under control of the CPU 1212, reads transmission data stored on a transmission buffer region provided in a recording medium such as the RAM 1214, the hard disk drive 1224, the DVD-ROM 1201, or the IC card, and transmits the read transmission data to a network or writes reception data received from a network into a reception buffer region or the like provided on the recording medium.

In addition, the CPU 1212 may cause all or a necessary portion of a file or a database to be read into the RAM 1214, the file or the database having been stored in an external recording medium such as the hard disk drive 1224, the DVD-ROM drive 1226 (DVD-ROM 1201), the IC card, etc., and perform various types of processing on the data on the RAM 1214. The CPU 1212 then writes back the processed data to the external recording medium.

Various types of information such as various types of programs, data, tables, and databases may be stored in a recording medium and subjected to information processing. The CPU 1212 may execute, on the data read from the RAM 1214, various types of processing including various types of operations, information processing, conditional judgement, conditional branching, unconditional branching, information retrieval/replacement, or the like described throughout the present disclosure and specified by instruction sequences of the programs, and writes the results back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may retrieve, out of the plurality of entries, an entry with the attribute value of the first attribute specified that meets a condition, read the attribute value of the second attribute stored in this entry, and thereby acquiring the attribute value of the second attribute associated with the first attribute satisfying a predetermined condition.

The above-described program or software module may be stored in the computer-readable medium on the computer 1200 or near the computer 1200. In addition, a recording medium such as a hard disk or a RAM provided in a server system connected to a dedicated communication network or the Internet can be used as the computer-readable medium, thereby providing the program to the computer 1200 via the network.

While the present invention has been described by way of the embodiments, the technical scope of the present invention is not limited to the above-described embodiments. It is apparent to persons skilled in the art that various alterations or improvements can be added to the above-described embodiments. It is also apparent from the described scope of the claims that the embodiments added with such alterations or improvements can be included the technical scope of the present invention.

Note that the operations, procedures, steps, stages, or the like of each process performed by an apparatus, system, program, and method shown in the claims, embodiments, or diagrams can be performed in any order as long as the order is not indicated by “prior to,” “before,” or the like and as long as the output from a previous process is not used in a later process. Even if the operation flow is described using phrases such as “first” or “next” in the claims, embodiments, or diagrams, it does not necessarily mean that the process must be performed in this order.

### EXPLANATION OF REFERENCES

10: test system;
50: calibration apparatus;
60: DUT;
100: test apparatus;
110: propagation unit;
120: optical power detection unit;
130: optical power calculation unit;
140: storage unit;
150: determination unit;
160: input unit;
170: setting instruction unit;
1200: computer;
1201: DVD-ROM;
1210: host controller;
1212: CPU;
1214: RAM;
1216: graphics controller;
1218: display device;
1220: input/output controller;
1222: communication interface;
1224: hard disk drive;
1226: DVD-ROM drive;
1230: ROM;
1240: input/output chip; and
1242: keyboard.

What is claimed is:

1. A test apparatus which detects an optical power of each wavelength of input light emitted from a device under test and including n (n is a natural number) mutually different wavelengths, the test apparatus comprising:
a propagation unit which is capable of switching n or more mutually different propagation wavelength characteristics with respect to the input light and propagates the input light including the n wavelengths from the device under test with n propagation wavelength characteristics;
an optical power detection unit which detects optical powers of n beams of propagation light propagated from the propagation unit with the n propagation wavelength characteristics; and
an optical power calculation unit which calculates an optical power for each of the n wavelengths included in the input light, from the optical powers of the n beams of propagation light detected by the optical power detection unit, based on the n propagation wavelength characteristics.

2. The test apparatus according to claim 1, wherein
at least one of the n propagation wavelength characteristics is a characteristic of propagating propagation light including at least two wavelengths among the n wavelengths.

3. The test apparatus according to claim 1, wherein
the optical power calculation unit back-calculates the optical power for each of the n wavelengths, from the optical powers of the n beams of propagation light, based on the n propagation wavelength characteristics.

4. The test apparatus according to claim 2, wherein
the optical power calculation unit back-calculates the optical power for each of the n wavelengths, from the optical powers of the n beams of propagation light, based on the n propagation wavelength characteristics.

5. The test apparatus according to claim 1, wherein
the optical power calculation unit back-calculates the optical power of each of the n wavelengths, from the optical powers of the n beams of propagation light, based on the n propagation wavelength characteristics identified in advance by using reference input light of each of the n wavelengths each having a known optical power.

6. The test apparatus according to claim 2, wherein
the optical power calculation unit back-calculates the optical power of each of the n wavelengths, from the optical powers of the n beams of propagation light, based on the n propagation wavelength characteristics identified in advance by using reference input light of each of the n wavelengths each having a known optical power.

7. The test apparatus according to claim 5, wherein
the n propagation wavelength characteristics include n propagation wavelength characteristic elements for each of the n wavelengths, thereby having a total of n×n propagation wavelength characteristic elements, and
the optical power calculation unit calculates the n propagation wavelength characteristics in advance by calculating the n×n propagation wavelength characteristic elements based on each known optical power of the reference input light for each of the n wavelengths and optical powers of n×n beams of reference propagation light propagated with the n propagation wavelength characteristics for each of the n wavelengths from the propagation unit to which the reference input light for each of the n wavelengths is input, the optical powers being detected by the optical power detection unit.

8. The test apparatus according to claim 6, wherein
the n propagation wavelength characteristics include n propagation wavelength characteristic elements for each of the n wavelengths, thereby having a total of n×n propagation wavelength characteristic elements, and
the optical power calculation unit calculates the n propagation wavelength characteristics in advance by calculating the n×n propagation wavelength characteristic elements based on each known optical power of the reference input light for each of the n wavelengths and optical powers of n×n beams of reference propagation light propagated with the n propagation wavelength characteristics for each of the n wavelengths from the propagation unit to which the reference input light for each of the n wavelengths is input, the optical powers being detected by the optical power detection unit.

9. The test apparatus according to claim 5, wherein
wavelengths of the n beams of reference input light include wavelengths other than the n wavelengths included in the input light, and a wavelength band of the n beams of reference input light at least partially overlap a wavelength band of the n wavelengths included in the input light,
the n propagation wavelength characteristics include n propagation wavelength characteristic elements for each of the n wavelengths, thereby having a total of n×n propagation wavelength characteristic elements, and
the optical power calculation unit calculates the n propagation wavelength characteristics in advance by calculating the n×n propagation wavelength characteristic elements based on each known optical power of the reference input light for each of the n wavelengths and optical powers of n×n beams of reference propagation light propagated with the n propagation wavelength characteristics for each of the n wavelengths from the propagation unit to which the reference input light for each of the n wavelengths is input, the optical powers being detected by the optical power detection unit, and using the n×n propagation wavelength characteristic elements having been calculated to interpolate the n×n propagation wavelength characteristic elements corresponding to the n wavelengths included in the input light.

10. The test apparatus according to claim 6, wherein
wavelengths of the n beams of reference input light include wavelengths other than the n wavelengths included in the input light, and a wavelength band of the n beams of reference input light at least partially overlap a wavelength band of the n wavelengths included in the input light,
the n propagation wavelength characteristics include n propagation wavelength characteristic elements for each of the n wavelengths, thereby having a total of n×n propagation wavelength characteristic elements, and
the optical power calculation unit calculates the n propagation wavelength characteristics in advance by calculating the n×n propagation wavelength characteristic elements based on each known optical power of the reference input light for each of the n wavelengths and optical powers of n×n beams of reference propagation light propagated with the n propagation wavelength characteristics for each of the n wavelengths from the propagation unit to which the reference input light for each of the n wavelengths is input, the optical powers being detected by the optical power detection unit, and using the n×n propagation wavelength characteristic elements having been calculated to interpolate the n×n propagation wavelength characteristic elements corresponding to the n wavelengths included in the input light.

11. The test apparatus according to claim 1, wherein
the optical power calculation unit back-calculates the optical power of each of the n wavelengths, from the optical powers of the n beams of propagation light, based on the n propagation wavelength characteristics identified in advance by using reference input light of each of m (m≠n) wavelengths each having a known optical power, and
the m wavelengths include wavelengths other than the n wavelengths, and a wavelength band of the m wavelengths at least partially overlaps a wavelength band of the n wavelengths.

12. The test apparatus according to claim 2, wherein
the optical power calculation unit back-calculates the optical power of each of the n wavelengths, from the optical powers of the n beams of propagation light, based on the n propagation wavelength characteristics identified in advance by using reference input light of each of m (m≠n) wavelengths each having a known optical power, and
the m wavelengths include wavelengths other than the n wavelengths, and a wavelength band of the m wavelengths at least partially overlaps a wavelength band of the n wavelengths.

13. The test apparatus according to claim 11, wherein
the n propagation wavelength characteristics include n propagation wavelength characteristic elements for each of the n wavelengths, thereby having a total of n×n propagation wavelength characteristic elements, and
the optical power calculation unit calculates the n propagation wavelength characteristics in advance by calculating the m×n propagation wavelength characteristic elements based on each known optical power of the reference input light for each of the m wavelengths and optical powers of m×n beams of reference propagation light propagated with the n propagation wavelength characteristics for each of the m wavelengths from the propagation unit to which the reference input light for each of the m wavelengths is input, the optical powers being detected by the optical power detection unit, and using the m×n propagation wavelength characteristic elements having been calculated to interpolate the n×n propagation wavelength characteristic elements corresponding to the n wavelengths included in the input light.

14. The test apparatus according to claim 12, wherein
the n propagation wavelength characteristics include n propagation wavelength characteristic elements for each of the n wavelengths, thereby having a total of n×n propagation wavelength characteristic elements, and
the optical power calculation unit calculates the n propagation wavelength characteristics in advance by calculating the m×n propagation wavelength characteristic elements based on each known optical power of the reference input light for each of the m wavelengths and optical powers of m×n beams of reference propagation light propagated with the n propagation wavelength characteristics for each of the m wavelengths from the propagation unit to which the reference input light for each of the m wavelengths is input, the optical powers being detected by the optical power detection unit, and using the m×n propagation wavelength characteristic elements having been calculated to interpolate the n×n propagation wavelength characteristic elements corresponding to the n wavelengths included in the input light.

15. The test apparatus according to claim 1, wherein
the n propagation wavelength characteristics are characteristics, each of which maintains or amplifies only optical powers of one or more distinct wavelengths among the n wavelengths and attenuates optical power of remaining wavelengths.

16. The test apparatus according to claim 1, wherein
the n propagation wavelength characteristics are characteristics, each of which maintains only optical powers of a plurality of distinct wavelengths among the n wavelengths and sets optical power of remaining wavelengths to zero or each of which sets only an optical power of one distinct wavelength among the n wavelengths to zero and maintains optical powers of remaining wavelengths.

17. The test apparatus according to claim 1, wherein
the propagation unit is capable of switching the n or more propagation wavelength characteristics by controlling at least one of a temperature, a voltage, a current, a charge, a magnetic flux, and a pressure applied to a material having variable optical characteristics, by using at least one of a servomotor, a piezoelectric element, and a bimetal to change a physical dimension of an optical path of propagation light, or by switching n or more propagation apparatuses that propagate light with mutually different propagation wavelength characteristics.

18. The test apparatus according to claim 1, further comprising
a determination unit which determines pass/fail of the device under test based on the optical power, which is calculated by the optical power calculation unit, for each of the n wavelengths.

19. A test method which detects an optical power of each wavelength of input light emitted from a device under test and including n (n is a natural number) mutually different wavelengths, the test method comprising:
propagating, by a propagation unit which is capable of switching n or more mutually different propagation wavelength characteristics with respect to the input light, the input light including the n wavelengths from the device under test with n propagation wavelength characteristics;
detecting optical powers of n beams of propagation light propagated from the propagation unit with the n propagation wavelength characteristics; and
calculating an optical power for each of the n wavelengths included in the input light, from the optical powers of the n beams of propagation light having been detected, based on the n propagation wavelength characteristics.

20. A computer program product comprising a computer instruction recorded on a non-transitory computer-readable medium, enabling a computer of a test apparatus to execute the computer instruction to cause the test apparatus which detects an optical power of each wavelength of input light emitted from a device under test and including n (n is a natural number) mutually different wavelengths to perform:
propagating, by a propagation unit which is capable of switching n or more mutually different propagation wavelength characteristics with respect to the input light, the input light including the n wavelengths from the device under test with n propagation wavelength characteristics;
detecting optical powers of n beams of propagation light propagated from the propagation unit with the n propagation wavelength characteristics; and
calculating an optical power for each of the n wavelengths included in the input light, from the optical powers of the n beams of propagation light having been detected, based on the n propagation wavelength characteristics.
